(19) United States
(12) Patent Application Publication
(10) Pub. No.: US 2004/0088354 A1
(43) Pub. Date: May 6, 2004

(54) Method for safely concluding network service contract

(75) Inventors: Kazuya Niisaka, Yokohama (JP); Takashi Hishikawa, Yokohama (JP); Yoshio Kawakami, Yokohama (JP); Takaaki Habara, Yokohama (JP); Mutsuharu Takesada, Yokohama (JP)

Correspondence Address: Christopher J. Fildes, Fildes & Outland, P.C., Suite 2, 20916 Mack Avenue, Grosse Pointe Woods, MI, 48236, US

(73) Assignee: Hitachi Electronic Service Co. Ltd.

(21) Appl. No.: 10/457,665

(22) Filed: Jun. 9, 2003

(30) Foreign Application Priority Data
Oct. 30, 2002 (JP) 2002-315489

(51) Int. Cl. G06F 15/16

(52) U.S. Cl. 709/203

(57) ABSTRACT

A system comprising an actual contracting terminal 13, a contracting network 1, a DNS server 11, a service contractor system 2, and a service provider system 3, connected via a communication network 4 so as to enable transmission/reception of data, the service being provided by the service provider system 2 to the contracting network 1, wherein the service provider system 3 starts providing service after the service contractor system 2 confirms that the domain name input from the actual contracting terminal 13 corresponds with the domain name of the contracting network 1 obtained by the service contractor system 2 when the actual contracting terminal 13 concludes the contract for having the service provided to the contracting network 1.

### FIELD OF THE INVENTION

The present invention relates to a method for safely concluding a contract for a network service.

### DESCRIPTION OF THE RELATED ART

Conventionally, in order for a user (customer) of a network to receive various services from other systems via a communication network, there is a need for the user to sign a contract for receiving the service from such system in advance.

In such case, the domain name of the network to which the user belongs is transmitted to the service provider. However, the service provider must confirm the validity of the information because the service provider cannot judge whether the transmitted domain name is the proper domain name of the network or not.

### SUMMARY OF THE INVENTION

The present invention aims at providing a method for safely concluding a service contract, by enabling the service provider to confirm whether the domain name transmitted from the user requesting contract for network service is valid or not with ease.

In order to achieve the object mentioned above, the present invention provides a method for safely concluding a contract for network service in a system comprising an actual contracting terminal 13, a contracting network 1 (being the object of the contract), a DNS server 11, a service contractor system 2, and a service provider system 3, which are connected so as to enable transmission and reception of data via a communication network 4, the service being provided by the service provider system 3 to the contracting network 1 including the actual contracting terminal 13, wherein the service provider system 3 starts providing the service after the service contractor system 2 confirms whether the domain name input through the actual contracting terminal 13 corresponds with the domain name of the contracting network 1 obtained by the service contractor system 2, when the actual contracting terminal 13 concludes the contract for receiving service by the contracting network 1.

Also, the present invention provides a method mentioned above, wherein the service contractor system 2 obtains a host name of the actual contracting terminal 13 based on an IP address of the actual contracting terminal 13 using the DNS server 11, and extracts the domain name of the contracting network 1 from the obtained host name.

### BRIEF DESCRIPTION OF THE DRAWINGS

FIG. 1 is a schematic view of the contract system of the present invention; and

FIG. 2 is a flow chart showing the process for a user to conclude a contract with a service contractor system to receive the network service.

### DETAILED DESCRIPTION OF PREFERRED EMBODIMENTS

The preferred embodiment of the present invention will now be explained based on examples and with reference to the accompanying drawings.

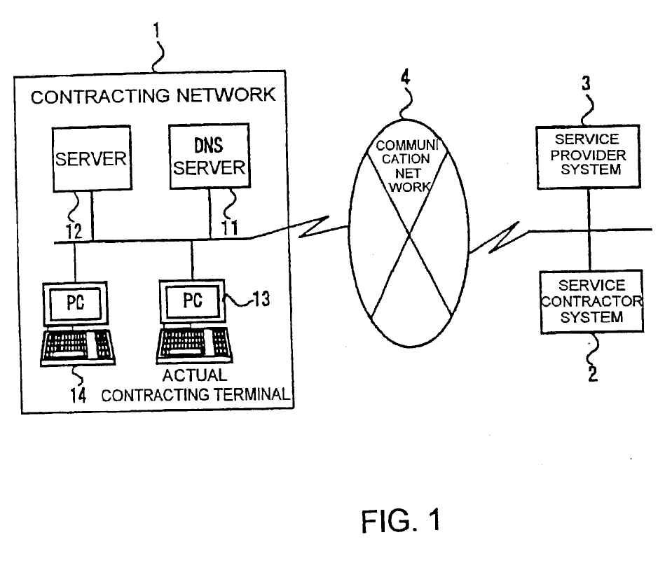

FIG. 1 is a conceptual view of a contract system according to the present invention.

In the drawing, reference 1 is a contracting network comprising an actual contracting terminal 13, a DNS server 11, a server 12, at least one personal computer (PC) 14 and the like. Reference 2 is a service contractor system, which concludes the contract concerning the network service upon receiving request for signing a contract from the actual contracting terminal 13, the detail being described hereinafter. Reference 3 is a service provider system, which provides a service to the contracting network 1 upon receiving a notice of acceptance for providing the service from the service contractor system.

The actual contracting terminal 13, the DNS server 11 within the contracting network 1, the service contractor system 2 and the service provider system 3 are connected so as to allow transmission/reception of data via a communication network 4.

When the actual contracting terminal 13 concludes a contract for providing service to the contracting network 1, a contract request is first transmitted from the actual contracting terminal 13 to the service contractor system 2. At this time, the domain name of the contracting network 1 is also transmitted.

The service contractor system 2 obtains the host name using the DNS server 11 based on the IP address of the actual contracting terminal 13, and extracts the domain name of the contracting network 1 (the actual contracting terminal 13) therefrom.

The service contractor system 2 confirms whether the domain name received from the actual contracting terminal 13 corresponds with the domain name extracted as mentioned above, and transmits a notice of acceptance for providing service to the service provider system 3 only when the two domain names are confirmed as corresponding with each other.

The service provider system 3 starts providing service to the contracting network 1 upon receiving the notice of acceptance for providing service.

When the two domain names do not match in the above-mentioned situation, the contract request is denied, and service is not provided.

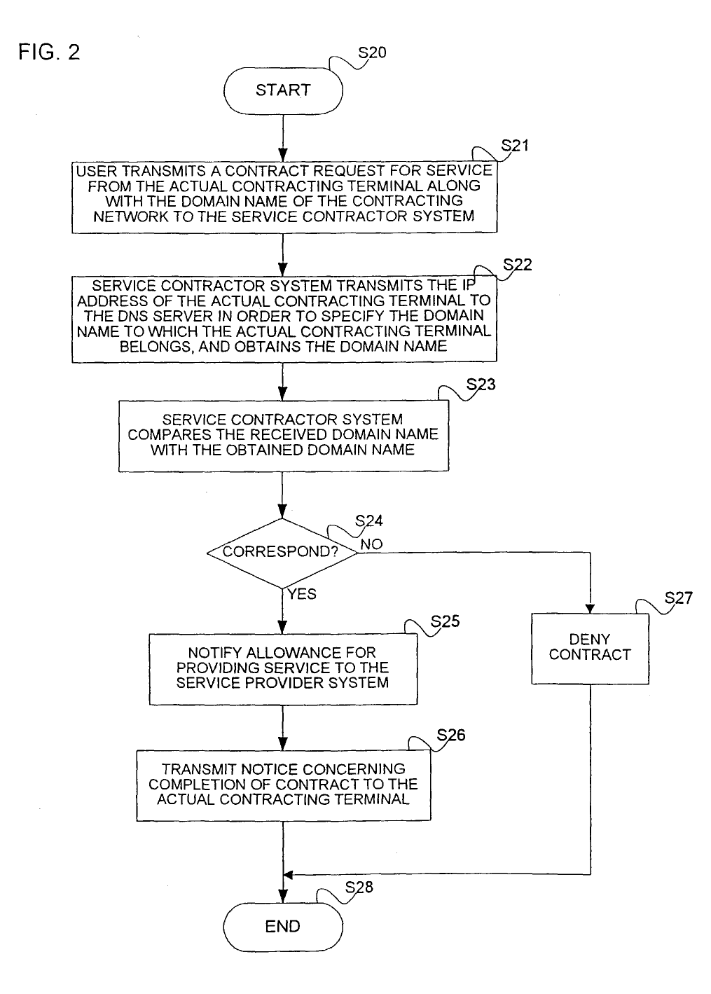

FIG. 2 is a flow chart of the process when a user (customer) concludes a contract with the service contractor system 2 in order to obtain network service.

The process starts in step S20. In step S21, the user transmits a contract request for service from the actual contract terminal 13 to the service contractor system 2. The transmission includes the domain name of the contracting network 1.

In step S22, the service contractor system 2 transmits the IP address of the actual contracting terminal 13 to the DNS server 11 to specify the domain name in which the actual contracting terminal 13 belongs, obtains the host name of the actual contracting terminal 13, and obtains (extracts) the domain name of the contracting network 1 from the obtained host name.

In step S23, the service contractor system 2 compares the domain name received in step S21 with the domain name obtained in step S22.

The result of comparison is checked in step S24. If the two domain names do not match, then in step S27 the contract request is denied and the process proceeds to step S28. If the two domain names do match, then in step S25 a notice of acceptance for providing service is transmitted to the service provider system 3, and in step S26 a notice concerning completion of contract is transmitted to the actual contracting terminal 13.

The process ends in step 828.

According to the present invention, the user can be specified easily based on a contract request from the actual contracting terminal, without having to specify the user beforehand by preexamination and the like, so that the contract for a network service can be concluded safely.

What is claimed is:

1. A method for safely concluding a network service contract in a system comprising an actual contracting terminal, a contracting network, a DNS server, a service contractor system, and a service provider system, which are connected via a communication network so as to enable transmission and reception of data, said service being provided by said service provider system to said contracting network including said actual contracting terminal,
wherein said service provider system starts providing service after said service contractor system confirms that a domain name input from said actual contracting terminal corresponds with a domain name of said contracting network acquired by said service contractor system when said actual contracting terminal concludes the contract for having the service provided to said contracting network.

2. A method for safely concluding a network service contract according to claim 1,
wherein said service contractor system acquires a host name of said actual contracting terminal from an IP address of said actual contracting terminal using said DNS server, and extracts the domain name of said contracting network from said host name.
